(19) United States
(12) Patent Application Publication
(10) Pub. No.: US 2016/0165344 A1
(43) Pub. Date: Jun. 9, 2016

(54) MUTUAL PERMISSION CUSTOMIZED AUDIO SOURCE CONNECTION SYSTEM

(71) Applicant: STAGES PCS, LLC, Princeton, NJ (US)

(72) Inventor: Benjamin D. Benattar, Cranbury, NJ (US)

(73) Assignee: STAGES PCS, LLC, Ewing, NJ (US)

(21) Appl. No.: 14/827,316

(22) Filed: Aug. 15, 2015

Related U.S. Application Data
(63) Continuation-in-part of application No. 14/561,972, filed on Dec. 5, 2014.

(51) Int. Cl. H04R 3/00; G10K 11/175

(52) U.S. Cl. CPC H04R 3/00; G10K 11/175; H04R 2420/01

(57) ABSTRACT

An audio communications system responsive to user permissions that enhance communications between two or more communication stations. The system allows two or more users to communicate audio information on a selected number of communication stations. The system is based on mutual permissioning with established connection sessions.

### CROSS REFERENCE TO RELATED APPLICATIONS

This application is a continuation-in-part of co-pending U.S. patent application Ser. No. 14/561,972 filed Dec. 5, 2014, U.S. Pat. No. ______, the disclosure of which is hereby incorporated herein by reference in its entirety.

### BACKGROUND OF THE INVENTION

1. Field of the Invention

The invention relates to communication systems and particularly customized audio communication systems establishing connection for delivery of audio information on the basis of a terminal identification.

2. Description of the Related Technology

Active noise reduction; active noise cancellation and active noise control are known in the prior art Elliot, S. J. et al., “Active Noise Control,” IEEE Signal Processing Magazine, October 1993 (pages 12-35), the disclosure of which is expressly incorporated by reference herein, describes the history and background of active noise control systems and describes the use of adaptive filters.

Kuo, Sen M. et al., “Active Noise Control: A Tutorial Review,” Proceeding of the IEEE, Vol. 87, No. 6, June 1999 (pages 943-973), the disclosure of which is expressly incorporated by reference herein, describes principles and systems for active noise control.

Kuo, Sen M. et al., “Design of Active Noise Control Systems with the TMS320 Family,” Application Report, Texas Instruments Digital Signal Processing Solutions, Digital Signal Processing Products—Semiconductor Group, SPRA042, June 1996, the disclosure of which is expressly incorporated by reference herein, describes specialized digital signal processors designed for real-time processing of digitized signals and details the design of an Active Noise Control (“ANC”) system using a TMS320 DSP.

United States Published Patent Application US 2014/0044275, the disclosure of which is expressly incorporated by reference herein, describes an active noise control system with compensation for error sensing at the ear drum including a subjective tuning module and user control.

Active noise control systems utilize various active filtration techniques and rely on algorithms to process source audio in order to reduce the influence of noise on the listener. This may be accompanied by modification of the source audio by combination with an “anti-noise” signal derived from comparing ambient sound to source audio at the ear of a listener.

Active noise control devices in the prior art suffer from being incapable of addressing the wide variation of ambient sound, dominant noise, acoustic sensors, specific characteristics of headphones or earphones or other listening devices, the type nature and characteristics of source audio (such as sound from a digital electronic device), and individual audio perceptions as each of these and other elements of sound interact to comprise a listening experience.

Adaptive noise cancellation is described in Singh, Arti. “Adaptive Noise Cancellation,” Dept. of Electronics & Communications, Netaji Subhas Institute of Technology, (2001). http://www.cs.cmu.edu/˜aarti/pubs/ANC.pdf. Accessed Nov. 21, 2014, the disclosure of which is incorporated herein. The customization according to the invention may be performed in accordance with the principles described therein.

U.S. Patent Application Publication No. US 2013/0325993 A1, the disclosure of which is incorporated by reference herein, discloses a method and system for group-based communication in a social networking space. The system is for managing and tracking social networking group events and does not contemplate free form connections for audio communications.

### SUMMARY OF THE INVENTION

It is an object of the invention to overcome limitations in social networking to provide real-time audio communications involving two or more stations.

Social networking systems allow subscribers to communicate with their friends and others. The permitted communications are typically static, for example texting, posting, etc. Social networking systems may also permit voice or audio communications however audio communications are either distribution of audio files or user-initiated “calls.” One limitation in social networking is the lack of any ad hoc communications audio communications without a user-initiated call.

The invention may, among other things, facilitate a desired interaction with sound on the basis of an identification of a station. The invention may allow a listener to combine one or more sources of sound on the basis of the source.

It is an object of the invention to provide a system that permits a subscriber to carry on audio communications with other subscribers selected, without requiring real-time mutual action to establish connections.

It is an object of the invention to suppress delivery of portions of audio information not significant to a social networking communication.

According to an embodiment of the invention the suppression may be executed by a subsystem as described in co-pending parent U.S. application Ser. No. 14/561,972. Alternatively, the suppression may be performed by attenuation of non-speech audio present at a station.

It is an object of the invention to provide a social networking audio communication system that allows a subscriber to adjust the system based on personal preferences. It is a further object to allow establishment of a connection for audio communications based on satisfaction of predefined criteria. The predefined criteria may include user specification of permissions, enable particular station connections, and/or other system, user, or station based parameters.

It is an object of the invention for the suppression subsystem to retain those aspects of the local and/or remote ambient sound environment that a listener identifies as desirable into the source or streamed listening environment, and to make one or more adjustments to enhance the resulting combined sound.

The audio suppression function may be implemented in one or more digital signal processors and/or adaptive filters operating on ambient, directional or directionless, source and noise audio in order to enhance delivery of desirable audio and damp delivery of undesirable audio. The invention may be implemented in a single device or in multiple components. The components may be connected wirelessly or in a wired fashion.

An active noise control system may have an adaptive filter having a source audio input and an audio signal output. A filtration control may be connected to the adaptive filter and a variable input control may be connected to the filtration control wherein the variable input control dynamically influences the filtration control. The active noise control system may have a variable input control that is a user control. The variable input control may be a dynamic audio analysis unit; an identification based variable input control; and/or a non-audio environmental identification based variable input control.

The invention may include an article of manufacture, a method, a system, and an apparatus for an audio customization system. The article of manufacture of the invention may include a computer-readable medium comprising software for a system for generating an audio signature or audio fingerprints. The invention may be embodied in hardware and/or software and may be implemented in one or more of a general purpose computer, a special purpose computer, a mobile device, or other dedicated or multipurpose device.

The article of manufacture of the invention may include a computer-readable medium comprising software for an active noise reduction system, comprising code segments for generating audio signatures.

The system of the invention may include a computer system including a computer-readable medium having software to operate a computer or other device in accordance with the invention.

The article of manufacture of the invention may include a computer-readable medium having software to operate a computer in accordance with the invention.

Various objects, features, aspects, and advantages of the present invention will become more apparent from the following detailed description of preferred embodiments of the invention, along with the accompanying drawings in which like numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 shows an embodiment of a mutual permission customized audio source according to an embodiment of the invention.

FIG. 2 shows a communications table which may be utilized in an embodiment of the invention.

FIG. 3 shows an authorization table which may be used in an embodiment of the invention.

FIG. 4 shows an embodiment of a user interface for a communications station.

FIG. 5 shows an illustration of an adaptive filter system.

FIG. 6 shows an embodiment of a mutual permission audio connection system acting in cooperation with a social networking system.

### DETAILED DESCRIPTION OF PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

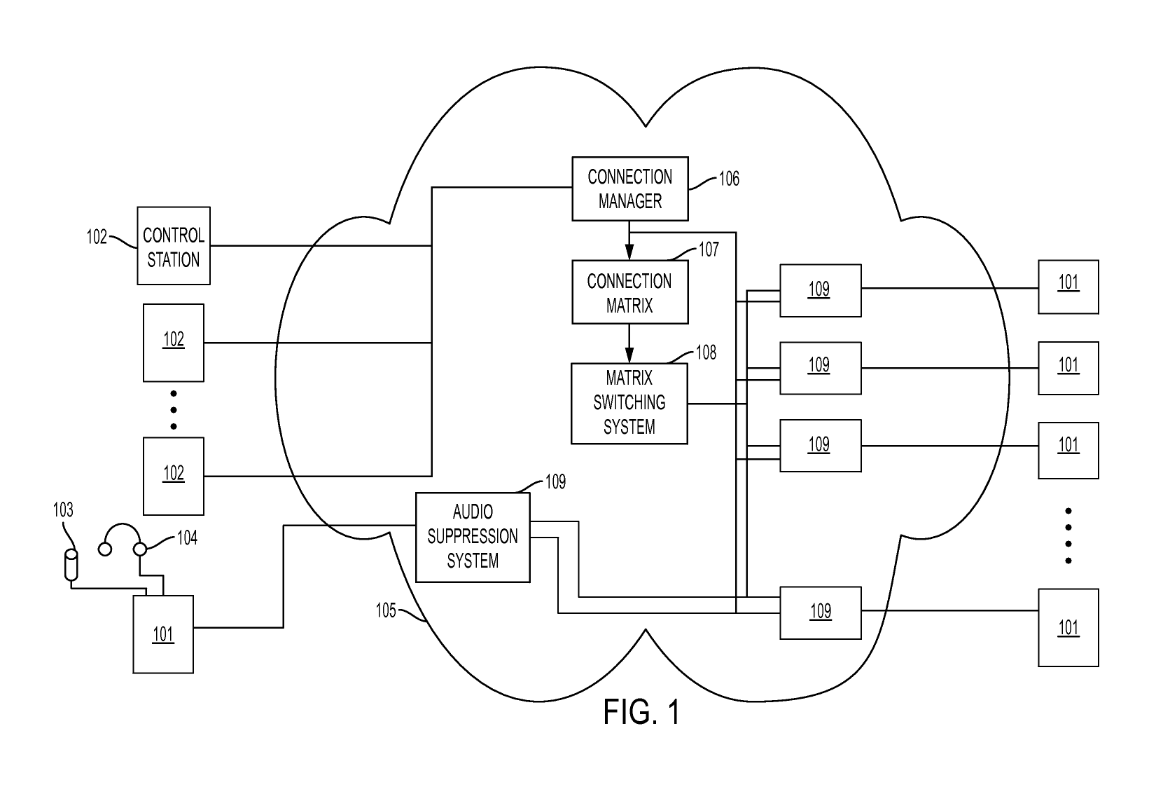

FIG. 1 shows an embodiment of a mutual permission audio source communications system. U.S. patent application Ser. No. 14/561,972, commonly assigned herewith discloses a customized audio system. U.S. patent application Ser. No. ______, filed on even date herewith, entitled Communication System for Establishing and Providing Preferred Audio, Atty. Docket No. 111003, shows a preferred audio communication system based on audio characteristics. The present invention takes advantage of aspects of a customized audio system but reduces the computational resources required by relying on a source identification in part, to select audio for processing. The system may be utilized to allow two or more users to communicate audio information according to permissions established by the users. A communications station or node is a device that interfaces a user to the system. Stations 101 may be portable communication devices such as smartphones, tablets, or dedicated communications stations. A control station 102 is utilized to provide connection management instructions to the system. A control station 102 may be integrated with a communications station 101. Advantageously, audio input devices such as a microphone 103 and audio output devices such as headphones 104 are connected to the communications stations.

Headphones are a pair of small speakers that are designed to be held in place close to a user's ears. They may be electroacoustic transducers which convert an electrical signal to a corresponding sound in the user's ear. Headphones are designed to allow a single user to listen to an audio source privately, in contrast to a loudspeaker which emits sound into the open air, allowing anyone nearby to listen. Earbuds or earphones are in-ear versions of headphones.

The system may be controlled so that a particular communication station will be in audio communication with one or more other communications stations 101. The control station 102 may require permissions from one or more of the communications stations 101 to establish and maintain audio communications. The permissions may be designated at a control station 102. Advantageously the control stations 102 may be client applications running on a desktop or other computing platform. A user may log into a control station 102 in order to manage and control audio communications to stations which the user is authorized to manage.

The control station may be connected by a network 105 such as the internet to a connection manager 106. The connection manager 106 may contain logic facilitating the identification of audio sources that each communications station has requested. The audio sources may be other subscriber stations which must be set up by their users to authorize communications. In addition the audio sources may include static audio sources such as radio stations or other broadcast facilities and signaling stations to provide information of a more general interest. Examples of signaling stations may include weather alerts, AMBER alerts, or school closing notifications. A control station 102 may be utilized to program the connection manager 106 to designate the sources that the communications station 101 is requesting.

Each individual computing device may have a physical or logical identification. The physical or logical identifications may be IP addresses, MAC addresses, telephone numbers, user numbers or any other identification token. When the communication manager 106 has received sufficient permissions to authorize a communication connection, the connection manager informs the connection matrix 107 of the enabled connection. The connection matrix 107 is connected to and controls a matrix switching system 108 which establishes authorized connections between communications stations 101.

It may be desirable to control the nature of or aspects of audio information which is communicated between communications stations 101. FIG. 1 illustrates an audio suppression system 109 between the communications station 101 and the matrix switching system 108. The audio suppression system 109 may advantageously be controlled according to instructions from a control station 102 provided to a communications manager 106. The communications manager 106 may provide control instructions to the audio suppression system 109.

Audio suppression system 109 may be in place to attenuate background noise or other portions of the audio information being communicated. Depending on the application, the audio suppression may be applied to inbound communications to a communications station 101 or outbound communications from a communication system 101. The audio suppression system 109 may be of the type described in the parent application Ser. Nos. 14/561,972 and ______ (Atty. Docket No. 111003).

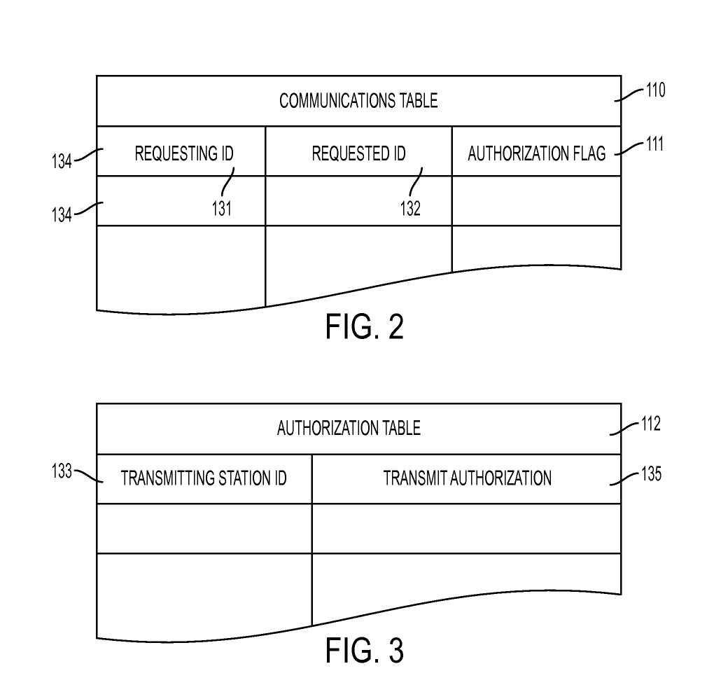

The control station 102 may be used to populate a communications table 110 as shown in FIG. 2. The communications table 110 may have a set of records 134 that include a requesting station ID field 131, a requested station ID field 132 and a mutual authorization flag field 111. FIG. 3 shows an authorization table 112 with records containing a transmitting station ID field 133 and transmit authorization flag 135. The control station 102 may provide an identification of a station and an identification of each station that the station wishes to include in its communications group. The communications table 110 may also include a flag field 111 to signal a mutual authorization to establish communications. The mutual authorization field 111 is activated when a station initiates a communication request to a second station which has previously been authorized by the second station. An authorization table 112 may include records identifying communications stations that do not require explicit authorization to establish communications. For example, a radio station could be set up so that it does not require authorization, for example, a subscription-based station. A radio station may also be set up so that it does require authorization. The radio station's subscription management system 113 would be responsible for communicating authorized identifications to the communications manager 106.

An entry may be created in a communications table 110 when an authorized request is made for a first communications station to be in communication with a second communications station. The entry 134 will include the ID of the first station as the requesting station ID 131 and the ID of the second station as a requested station ID 132. If an authorized request for the second station to be in communication with the first station had not been previously made an entry is created in the communications table 110, an invitation may be transmitted to the second station to establish communication. If that invitation is accepted, a second entry may be created in the communications table 110 indicating the ID of the second station seeking authorization to establish communications. A process may be used to determine when complementary entries exist in the communications table 110, and if so, set the authorization flags 111 to authorize communications and having an authorized field set.

If a station requests communication authorization with a second station which had previously authorized communication, a record may be entered in the communications table 110 indicating the communication pair and setting the authorization flag 111. The communications manager 106 identifies all communication pairs which have been mutually authorized either by specific action or by default and places an entry in the connection matrix 107. The connection matrix 107 controls the matrix switching system 108 to establish a communication channel between the stations of the communication pair.

According to an advantageous feature, an address book may be provided in or in connection with each station. The address book may be a personal look-up table to identify a correlation between a user-identifiable information, like a name, and a logical identification like a station identification number.

In this fashion, a system can be established where a group of friends request communications. Each friend can listen in on audio originating from a paired communications station. The friends may modify the authorizations on an ad hoc basis.

According to an advantageous feature, each station may include a communication activation control. In this fashion, the user of each station may control whether the station broadcasts, receives broadcasts, broadcasts and receives or does not broadcast and does not receive.

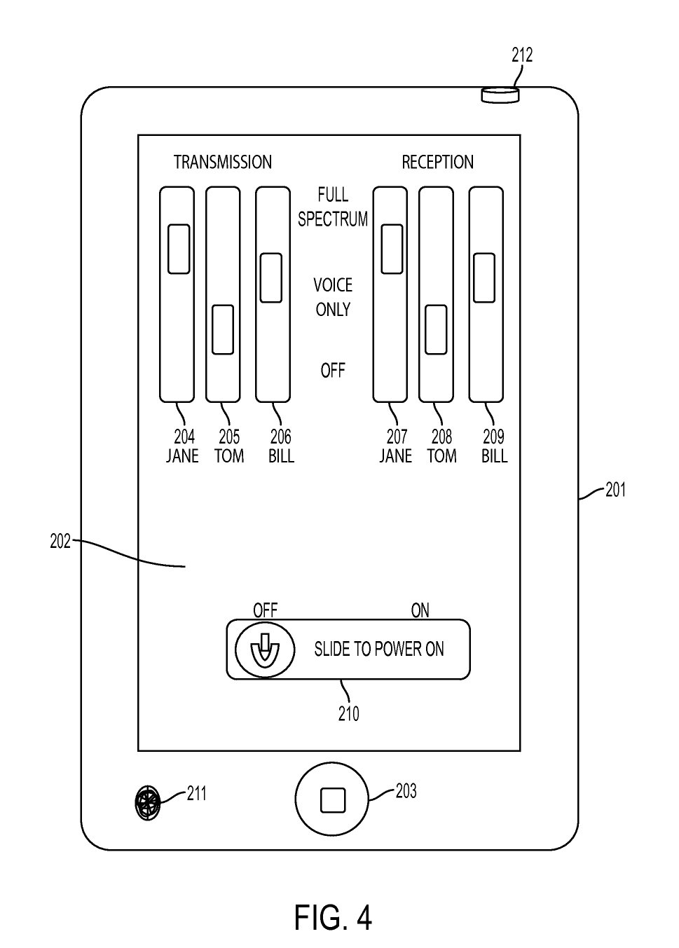

FIG. 4 shows an embodiment of a user interface for the station, implemented on a personal electronic device, 201, such as a tablet or smartphone to control the selective audio suppression and other audio customization. The device may have a touch screen 202 and a mechanical control 203. The device shown in FIG. 2 may be implemented in an application. FIG. 2 shows three level sliders 204, 205 and 206 for paired communication stations for transmission and three for reception. There is an on/off switch 210 that is also a touch control. The tablet 201 may have an on-board microphone 211 and a stereo headphone jack 212. Audio input may be provided by an onboard radio player or an external input.

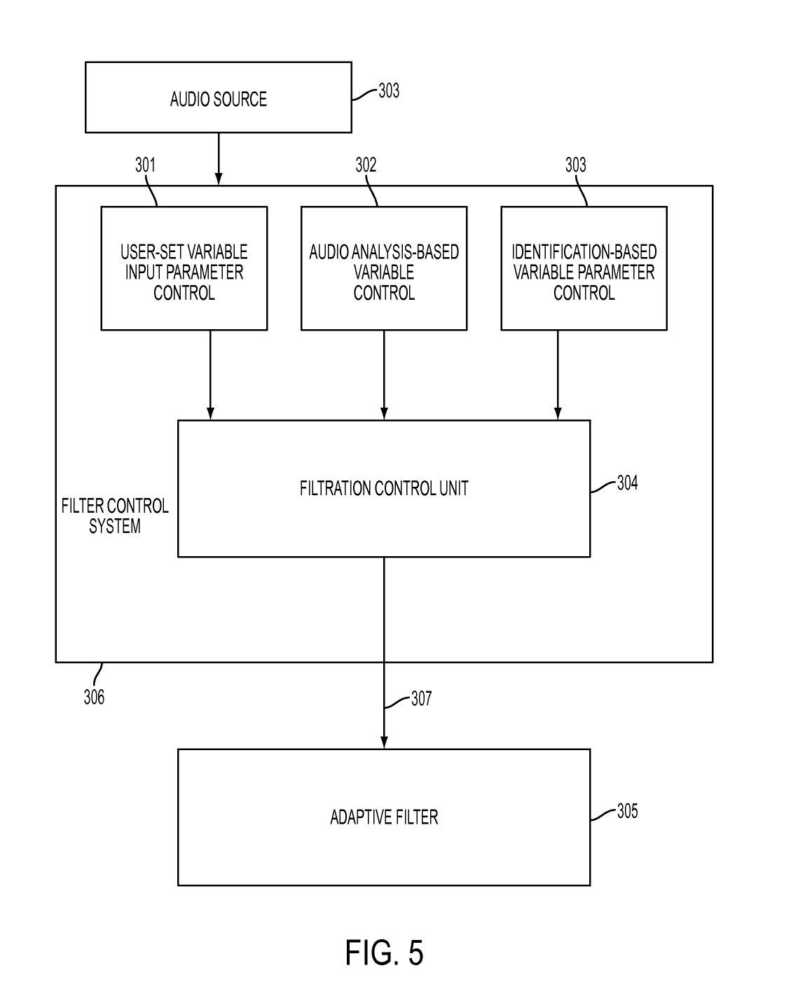

FIG. 5 shows a detailed illustration of an adaptive filter 305 and filter control system 306 which may be used for audio suppression. The filter control system 306 may respond to user variable input parameter control 301, audio analysis based variable control 302, and identification based variable parameter control 303.

The filtration control unit 304 mixes the variable parameters to create an adaptive filter control signal 307. The adaptive filter control signal defines the transfer function used by the adaptive filter 505.

U.S. application Ser. No. 14/561,972, the disclosure of which in incorporated herein, describes user-set variables, audio analysis-based variables, and identification-based variables that may be used with the audio suppression system 109.

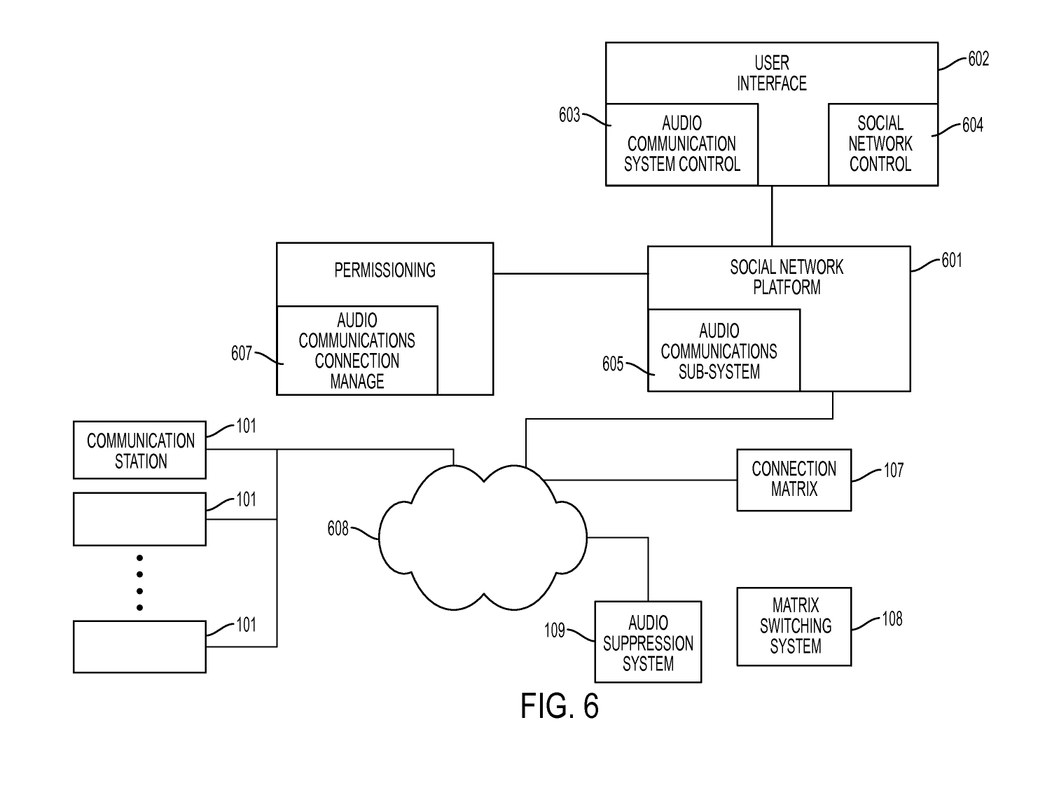

FIG. 6 shows an embodiment of a mutual permission audio connection system acting in cooperation with a social networking system. In the embodiment of FIG. 6 a mutual permission audio communication system is shown working in connection with a social network platform. An example of an established social network platform is the Facebook platform. The Facebook platform facilitates add-on systems which may take advantage of the Facebook functionality for certain operations such as registration and log-on. In the embodiment illustrated in FIG. 6 an established social network platform 601 may be controlled or operated through a user interface 602. The user interface may include an audio communication control station user interface 603, along with the intrinsic social network user interface 604.

The operation of the communication system may be controlled through an audio communication subsystem 605 which may be associated with the established social network platform 601 or may be independent, connected through a communications network 608. In either case the audio communication control station user interface 603 may be separate from the social network user interface 604, freestanding and connected through communications network 608. Communication stations 101, previously described, may be connected through communications network 608. A connection matrix 107 and matrix switching system 108 along with audio suppression system 109, all previously described, may also be connected to the communications stations and audio communication subsystem through a communications network 608. The established social network platform 601 may be connected to an intrinsic permissioning system 606. The connection manager 607, having the functionality previously described for connection manager 106, may be incorporated in the permissioning system 606 of the established social network platform 601, or connected to connection matrix 107.

The techniques, processes and apparatus described may be utilized to control operation of any device and conserve use of resources based on conditions detected or applicable to the device.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of audio signature generation and automatic content recognition have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An audio communications system comprising:
a connection manager responsive to one or more control stations;
a connection matrix specifying connections between two or more communication stations responsive to said connection manager; and
a matrix switching system establishing connections between communication stations according to said connection matrix.

2. An audio communications system according to claim 1 further comprising one or more audio suppression systems connected to said matrix switches and said connection manager.

3. An audio communications system comprising:
an audio communication matrix responsive to a user interface to set requested communication paths; and
an audio communication permissioning system connected to said audio communications connection matrix wherein said audio communications connection matrix specifies open communication paths based on said permissioning system.

4. An audio communications system according to claim 3 wherein said audio communications matrix is connected to a network and user communications between subscribing users are established in accordance with authorization through said permissioning system.
